(19) United States
(12) Patent Application Publication
(10) Pub. No.: US 2026/0152086 A1
(43) Pub. Date: Jun. 4, 2026

(54) DYNAMIC ELECTRIC VEHICLE SUPPLY EQUIPMENT RESET SYSTEM

(71) Applicant: PowerFlex Systems, LLC, San Diego, CA (US)

(72) Inventors: Zachary GOMEZ, Sunnyvale, CA (US); Yazid MAZAHREH, San Mateo, CA (US)

(21) Appl. No.: 19/397,754

(22) Filed: Nov. 21, 2025

Related U.S. Application Data
(60) Provisional application No. 63/726,400, filed on Nov. 29, 2024.

(51) Int. Cl. B60L 53/68; B60L 53/66; B60L 53/67

(52) U.S. Cl. CPC B60L 53/68; B60L 53/66; B60L 53/67; B60L 2250/16

(57) ABSTRACT

Certain aspects of the present disclosure provide techniques for dynamically resetting an electric vehicle supply equipment (EVSE). An example EVSE includes: a control circuitry within the EVSE, the control circuitry configured to control the EVSE; and a reset circuitry coupled to the control circuitry, the reset circuitry configured to: receive a reset signal; and cause a reset of the EVSE based on the reset signal.

### CROSS-REFERENCE TO RELATED APPLICATION

This Application claims the benefit of and priority to U.S. Provisional Patent Application No. 63/726,400, filed on Nov. 29, 2024, the entire contents of which are hereby incorporated by reference.

### INTRODUCTION

Electric vehicle (EV) charging infrastructure is a rapidly evolving field given the popularity of EVs. EV charging stations often rely on backend systems (e.g., local and/or cloud-based backend systems) to manage charging sessions. For example, when an EV connects to an EV charging station, the EV charging station sends a status update to a backend system, which then initiates and manages a charging session. The backend system maintains databases of active charging sessions across multiple sites and EV charging stations. However, this centralized approach utilizing the backend system may be hindered when the EV charging stations are unable to communicate with the backend system. For example, when the communication between an EV charging station and the backend system is lost, the backend system would not be able to receive any status update from the EV charging station. Thus, the backend system would not be able to initiate any charging session for the EV charging station. As the EV charging infrastructure continues to expand, problems associated with the lost connections between the EV charging stations and backend systems are expected to affect more users.

### SUMMARY

One aspect provides an electric vehicle supply equipment (EVSE). The EVSE includes: a control circuitry within the EVSE, the control circuitry configured to control the EVSE; and a reset circuitry coupled to the control circuitry, the reset circuitry configured to: receive a reset signal; and cause a reset of the EVSE based on the reset signal.

Another aspect provides a method for dynamically resetting an EVSE. The method includes: detecting that an EVSE is not communicating with a remote control system; setting a status associated with the EVSE indicating an offline state in which the EVSE is not communicating with the remote control system; receiving, from a user device, at least one of a first request for the EVSE to charge an electric vehicle, or a request to reset the EVSE; determining whether the reset of the EVSE is allowed in accordance with a reset condition being satisfied; and sending, to the user device, a notification based on the determination of whether the reset of the EVSE is allowed.

Another aspect provides another method for dynamically resetting an EVSE. The method includes: receiving, by a wireless communications device, a notification including an authorization request for performing a reset of an EVSE; displaying, by a user interface, the notification; receiving, by the user interface, an indication from a user authorizing the reset of the EVSE; sending, by the wireless communications device, a user authorization of the reset of the EVSE; receiving, by the wireless communications device, an instruction for performing the reset of the EVSE; displaying, by the user interface, the instruction for performing the reset of the EVSE; and sending, by the wireless communications device, a reset request to the EVSE.

Other aspects of the present disclosure provide one or more non-transitory, computer-readable mediums comprising instructions that, when executed by one or more processors of one or more processing systems, cause the one or more processing systems to perform the aforementioned methods as well as those further described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The aspects set forth in the drawings are illustrative and exemplary in nature and not intended to limit the disclosure. The following detailed description of the illustrative aspects can be understood when read in conjunction with the following drawings, where like structure is indicated with like reference numerals and in which:

FIG. 1 depicts a computing environment for a dynamic EVSE reset system, according to aspects provided herein;

FIG. 2 depicts a software configuration for an edge environment for a dynamic EVSE reset system, according to aspects provided herein;

FIGS. 3A-3C depict device configurations for an edge environment for a dynamic EVSE reset system, according to aspects provided herein;

FIGS. 4A-4C depict hardware that may be utilized for the devices from FIGS. 3A-3C, according to aspects provided herein;

FIG. 5 depicts a software configuration for a cloud environment for a dynamic EVSE reset system, according to aspects provided herein;

FIG. 6 depicts an example of a dynamic EVSE reset system, according to aspects provided herein;

FIG. 7 depicts another example of a dynamic EVSE reset system, according to aspects provided herein;

FIGS. 8A and 8B depict an example process flow for a dynamic EVSE reset system, according to aspects provided herein;

FIG. 9 depicts an example method for a dynamic EVSE reset system, according to aspects provided herein;

FIG. 10 depicts another example method for a dynamic EVSE reset system, according to aspects provided herein;

FIG. 11 depicts an example processing system configured to perform the methods described herein, according to aspects provided herein; and

FIG. 12 depicts another example processing system configured to perform the methods described herein.

### DETAILED DESCRIPTION

Aspects disclosed herein include systems and methods for dynamically resetting an EVSE (also may be referred to herein as a charging station or an EV charging station). Some aspects utilize an apparatus that includes a control circuitry within an EVSE, where the control circuitry is configured to control the EVSE; and a reset circuitry coupled to the control circuitry, where the reset circuitry is configured to receive a reset signal and cause a reset of the EVSE based on the reset signal. Aspects of systems and methods for dynamically resetting an EVSE, incorporating the same, will be described in more detail, below.

Typically, a malfunctioning EVSE requires manual, in-person troubleshooting to determine whether there may be an issue with configuration, communication with a backend system, and/or physical hardware of the EVSE. Thus, a problem associated with a malfunctioning EVSE may include, for example, service interruption attributable to the required troubleshooting. As a first pass, the EVSE may be reset to assess if the issue can be cleared by a reset. However, a conventional EVSE lacks an external reset function, and in order to reset the EVSE, an operator may need to manually flip a breaker connected to the EVSE. Manually flipping a breaker is inconvenient because it requires access to a breaker panel, which is often significantly remote from the EVSE. Additionally, manually flipping a breaker poses potential safety risks when performed too often and/or without a qualified electrician. Further, manually flipping a breaker increases service interruption due to the time it takes for actually contacting the electrician and for the electrician to get to the breaker panel in order to flip the breaker. In some cases, additional troubleshooting may be needed by the electrician before and/or after a reset to actually put the EVSE back into a working condition, further extending the service interruption. Moreover, in some cases, a single breaker may take down multiple EVSEs, including ones that are not in an error state, thus degrading the overall system. Manually flipping a breaker may also affect other equipment based on electrical infrastructure.

One way to reduce the service interruption described above is to reset the EVSE without accessing the breaker panel, such as by sending a reset command directly to the EVSE via a wired connection. However, directly sending a reset command to the EVSE also requires a knowledgeable technician or operator to be present, who possesses the knowledge on how to connect to the EVSE and what command(s) to send to troubleshoot and/or reset the EVSE. The requirement for the knowledgeable technician or operator results in similar issues with service interruption as described above regarding the requirement for the qualified electrician. For example, contacting the technician or operator and the technician or operator performing the required troubleshooting results in unwanted service interruption.

Other ways to reduce the service interruption include having a dedicated reset switch placed near or on each EVSE and performing periodically scheduled resets. However, having a dedicated reset switch near or on each EVSE poses potential security issues because it lacks a barrier around the reset switch to prevent accidental or gratuitous reset attempt by anyone near the EVSE. Accidental and gratuitous reset attempts increase the service interruption. Moreover, performing periodically scheduled resets may not necessarily reduce the service interruption, for example, if the service interruption starts immediately after a scheduled reset and persists until the next scheduled reset.

Aspects described herein may overcome the aforementioned problems associated with troubleshooting and/or resetting a malfunctioning EVSE, and provide improvement to the technology of controlling an EVSE, for example, by providing a seamless and secure solution that utilizes a user device, such as a mobile device running a mobile application (also referred to herein as an app). Some aspects provide a reset capability that does not require access to a breaker panel or technical assistance to connect directly to the EVSE, thus enabling an improved dynamic reset of the EVSE. Moreover, certain aspects include an authentication process that ensures that only authenticated users are able to reset the EVSE, thus preventing accidental or gratuitous resets. Resetting the EVSE as a first pass by utilizing the methods described herein can either put the EVSE back into a state in which the EVSE can charge an EV or allow further troubleshooting to be more targeted, as the reset attempt has already been made even before a technician begins troubleshooting (thus reducing the length of a service interruption in certain cases). Moreover, resetting the EVSE based on the methods described herein can generate one or more metrics that provide information relating to the reset attempt as well as other information relating to the state of the EVSE. Thus, even if the reset attempt is not successful, the generated metrics can enable the more targeted troubleshooting which can shorten the service interruption.

In certain aspects, a user may notice that an EVSE is malfunctioning by physically observing the EVSE. For example, the EVSE may have a user interface that indicates that the EVSE is not working properly and/or needs a reset. Alternatively, if the user attempts to charge an EV by connecting the EV to the EVSE, a remote control system may determine that the EVSE is not working properly and send a notification to a user device of the user to prompt the user about the state of the EVSE, for example, via a mobile app. In certain aspects, the user may initiate a reset request through the mobile app, which may authenticate the user to send the reset request by communicating with the remote control system. When the user has been authenticated, the user may utilize the user device to send a reset request through a wireless communications device on the user device using a wireless communications method (e.g., via radio frequency identification (RFID), Bluetooth, or Near Field Communication (NFC)). The wireless communications device on the user device sends the reset request to a wireless communications module on the EVSE to trigger a reset signal to a control circuitry of the EVSE. In certain aspects, the wireless communications module may be retrofitted onto or within the EVSE to communicate or interface (e.g., directly) with the control circuitry of the EVSE to trigger a reset of the EVSE. Adding or retrofitting the wireless communications module onto the EVSE (e.g., an existing EVSE) enables the reset capability described herein without adding an extensive infrastructure upgrade. In certain aspects, the wireless communications module may be embedded within the EVSE (e.g., on a reset circuitry connected to the control circuitry). For example, such wireless communications module may be an existing communications interface on or within the EVSE, and may be used to communicate or interface (e.g., directly) with the control circuitry of the EVSE to trigger the reset of the EVSE.

By utilizing a user device, such as a mobile device running a mobile app, certain aspects of the present disclosure allow only an authenticated user to initiate a reset of the EVSE, which beneficially prevents unauthorized or accidental resets that cause unwanted service interruption. Moreover, some aspects may allow the reset of the EVSE to occur without flipping a breaker via a breaker panel or physically interfacing with the EVSE to directly send a reset command (e.g., by using a cable). Thus, the reset of the EVSE may be initiated without contacting a qualified electrician or a knowledgeable technician or operator, which reduces the associated service interruption.

Other beneficial technical effects and/or advantages of various aspects of the present disclosure include provision of a non-disruptive reset mechanism that targets a control circuitry of an EVSE without interrupting the overall power supply of a charging site, which prevents disruptions to other systems or EVs charging nearby. Moreover, removing the need to access a breaker panel to trigger a reset of an EVSE reduces the need for handling physical switches or breakers, reducing potential safety risks and operational interruptions. Additionally, as certain aspects of the present disclosure utilize a mobile app that interacts with a remote control system of an EVSE, the remote control system can allow a reset of the EVSE through a mobile device only when a reset of the EVSE has not already been performed by another user (e.g., based on information accessible by the remote control system), thus further streamlining the diagnostic and recovery process for the EVSE by eliminating unwanted repeated reset attempts.

### Example Computing Environment for Dynamic EVSE Reset System

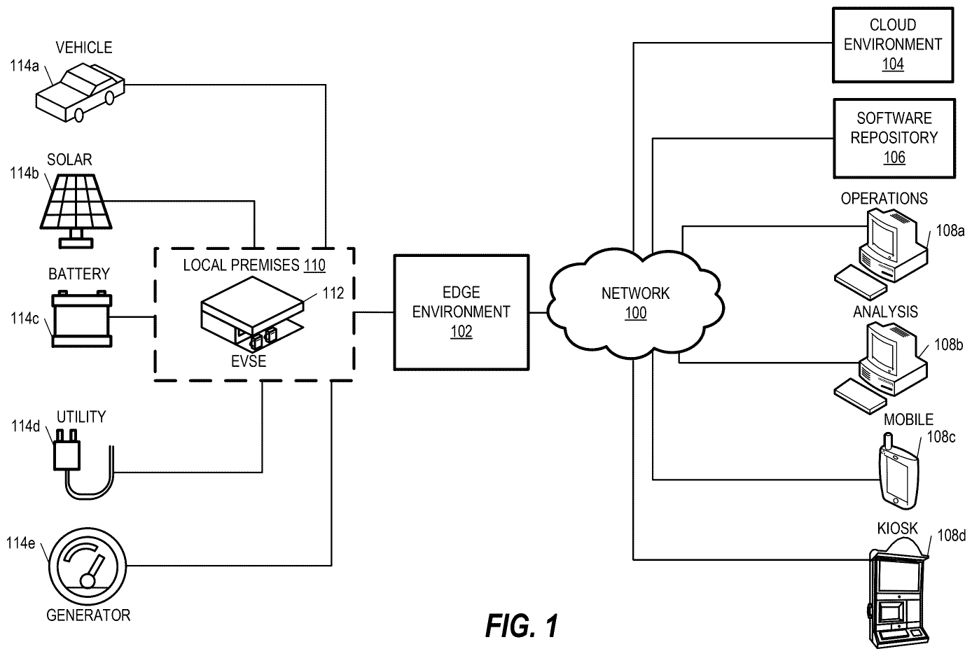

Referring now to the drawings, FIG. 1 depicts a computing environment for a dynamic EVSE reset system, according to aspects provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at a local premises site 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as charging of electric vehicles (e.g., EV 114a) using EVSE 112 and controlling one or more of various distributed energy resources (DERs), such as solar device 114b, BESS 114c, utility grid 114d, and/or generator 114e (e.g., an on-site diesel, natural gas, or other type of fueled generator). Generally, the aforementioned DERs may provide energy to the EVSE 112 and/or use energy from the EVSE 112 (e.g., by way of a backflow of energy from EV 114a to other aspects of site 110). In some aspects, EVSE 112 may send excess energy back to the BESS 114c and/or to utility grid 114d. Generally, edge environment 102 may monitor and/or modify the energy sent to and received from the DERs to optimize various tasks, such as charging of EV 114a.

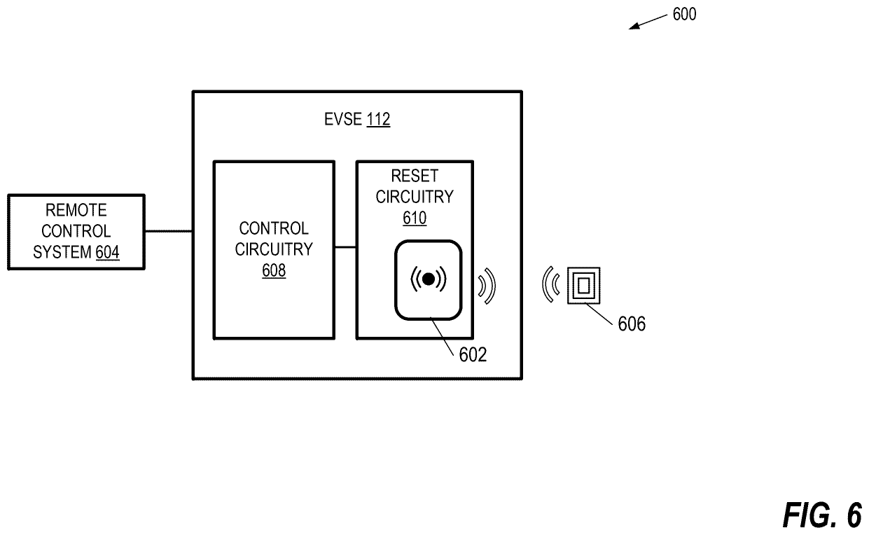

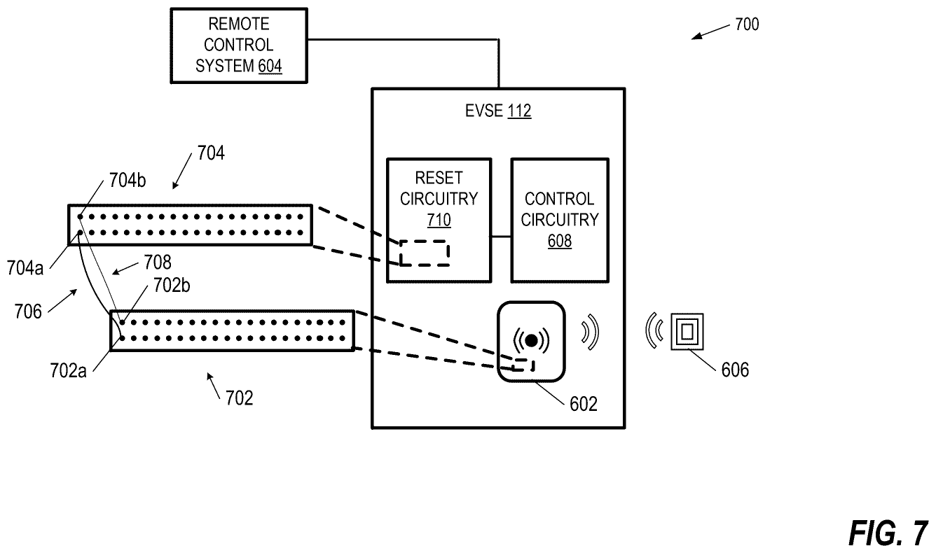

EVSE 112 may utilize one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level EVSEs, as applicable. Generally, the “level” of an EVSE refers to the power level and/or ability to provide electric power to a device being charged. In certain aspects, the EVSE 112 includes a control circuitry and a reset circuitry, as described further herein with respect to, for example, FIGS. 6 and 7.

Edge environment 102 is configured as an interface between various aspects of site 110 and network 100. In various aspects, compute resources for performing different functions at a site, such as control or optimization of EV charging, may be split between local compute resources in edge environment 102 and remote compute resources, for example, in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some aspects may be configured such that the cloud environment 104 may serve a plurality of edge environments 102 that each serve one or more sites 110, one or more EVSEs 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some aspects, software repository 106 may be configured as a proprietary service and/or may be provided by a third-party, such as GitHub™. Additionally, some aspects may be configured such that the software repository 106 is provided by the same entity that manages the cloud environment 104. As such, these aspects may be configured such that software repository 106 and cloud environment 104 may be combined.

With respect to the ancillary devices 108, the operations device 108a may be utilized to monitor and/or alter operations of the computing environment provided in FIG. 1. The analysis device 108b may analyze utilization, operation, charging, and/or other features of the computing environment provided in FIG. 1. The mobile device 108c may represent an administrator device and/or a user device. As a user device, the mobile device 108c may initiate charging, perform payment, and/or perform other user-specific actions. In certain aspects, the mobile device 108c may be used as a user device for dynamically resetting an EVSE, as described further herein with respect to, for example, FIGS. 6 and 7. As an administrator device, the mobile device 108c may perform administrative operations, analysis, and/or other actions. The kiosk device 108d may be located at one of the EVSEs 112 and/or remote therefrom and may provide user-specific or administrative actions, similar to that of the mobile device 108c. In some aspects, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some aspects may not be configured in this manner. Specifically, some aspects may utilize a kiosk device 108d that is local at the site 110, which may communicate via a local network and/or the network 100 for providing the services described herein.

### Example Edge Environment for Dynamic EVSE Reset System

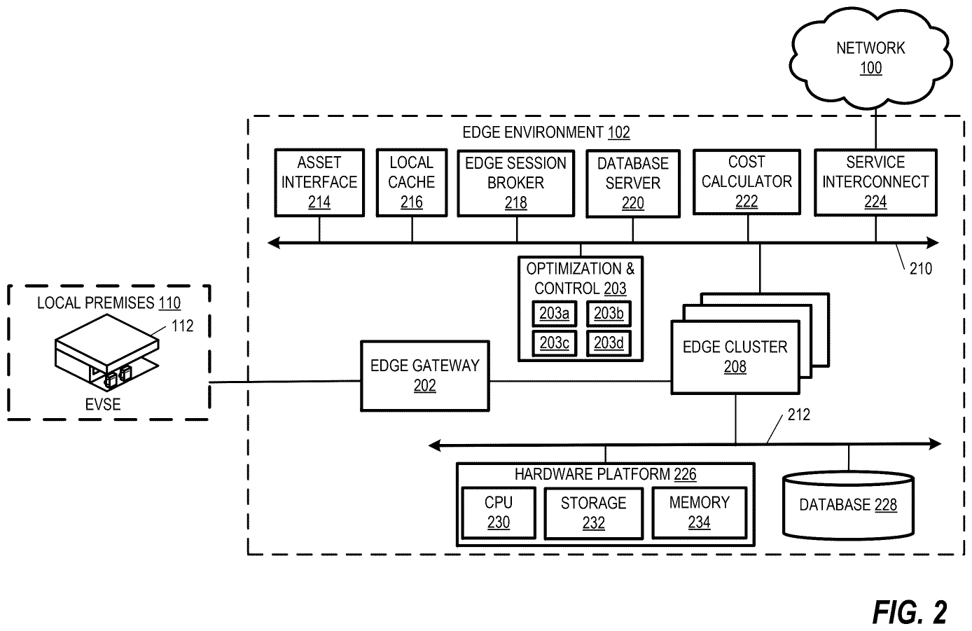

Referring now to FIG. 2, the edge environment 102 may be coupled to the site 110 via an edge gateway 202. Edge environment 102 may be operatively coupled to aspects of site 110, such as EVSE 112 via edge gateway 202. Edge environment 102 further includes an edge cluster 208, which is coupled to communication bus 210 and hardware bus 212. Communication bus 210 is coupled to optimization and control manager 203, asset interface 214, local cache 216, edge session broker 218, database server 220, cost calculator 222, and service interconnect 224 in this example. Hardware bus 212 is coupled to hardware platform 226, which may include one or more processors, such as CPU 230, one or more storage components 232, one or more memory components 234, and/or other hardware components. Also coupled to hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

Communication bus 210 and hardware bus 212 may be utilized to facilitate operation of all services that run in edge environment 102 and communicate with each other via a distributed message streaming system. The coupling of the aforementioned services may be accomplished in some aspects via a distributed message streaming system, such as NATS.

In the depicted example, EVSE 112 is configured for communication with edge environment 102 via edge gateway 202, such as via a short-range wireless network technology, such as via a Zigbee® PAN. The edge gateway 202 may be configured to receive data, such as electric vehicle charging data, price change data, vehicle data, etc. from the EVSE 112 and/or vehicles that are being charged via the connection with the site 110 (of FIG. 1).

In some aspects, edge gateway 202 may be configured to abstract data received from various aspects of site 110 (of FIG. 1), such as EVSE 112, to remove protocol-specific distinctions. For example, a first EVSE may utilize a first communication protocol and/or billing protocol and a second EVSE may utilize a second communication protocol and/or billing protocol. Edge gateway 202 may receive data packets from both the first EVSE using the first communication protocol and the second EVSE using the second communication protocol and may transform the received data into a protocol-agnostic format prior to providing the data to edge cluster 208. This may allow wide interoperability between edge environment 102 and various types of hardware (e.g., EVSE 112) at a site.

Edge cluster 208 is the central message center in various aspects. For example, when a user plugs a vehicle into an EVSE 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for EVSE 112.

The edge session broker 218 may produce data or signals that are sent to the edge cluster 208, which may be sent to the edge gateway 202 for potentially sending back to one or more of the EVSEs 112. Information that may be reported might include current delivered over time (e.g., amperes), total energy delivered (e.g., kWh), power delivered over time (e.g., kW), voltage at the EVSE over time (e.g., V), EVSE state (e.g., connected, disconnected, offline, etc.), connectivity state, charging state, etc. The EVSEs 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. A set-point may be a value for a parameter (or a set of values for a set of parameters), such as a charging rate. In certain aspects, the optimization and control manager 203 may include a database layer 203a to store data related to site configurations; an orchestration layer 203b to gather data, trigger optimizations, and/or issue set-points (e.g., provide the calculated set-points to energy assets); an optimization layer 203c to formulate and solve optimization problems to calculate set-points; and/or a control layer 203d for higher frequency feedback based controls (e.g., for modifying set-points to respond to fast time-scale events).

Optimization and control manager 203 may determine when optimization set-points need to be updated. Examples of when optimization set-points need to be updated include, but are not limited to: (1) when a new energy asset is installed at a site, (2) when a new vehicle to be charged arrives at a site, (3) when a measured value such as load or generation changes, (4) when a system parameter such as the target energy for a vehicle is updated, (5) when an external event occurs (such as a demand response event), and/or (6) at a fixed cadence (e.g., every 5 minutes). When it is determined that the optimization set-points need to be updated, optimization and control manager 203 may collect data needed for optimization, including optimization configuration from the cloud environment 104 of FIG. 1 (which can also be cached at edge environment 102) and state information from edge environment 102 and/or cloud environment 104. Examples of the optimization configuration include, but are not limited to: network and equipment constraints, optimization parameters such as the precision and timeout settings, etc. In certain aspects, the state information from edge environment 102 and/or cloud environment 104 includes the states of the energy assets, as well as other state information including EV driver preferences, price signals, and grid signals. Further, optimization and control manager 203 may perform optimization to calculate new/updated set-points. In certain aspects, optimization and control manager 203 may (e.g., optionally) run a fast time-scale control loop which adjusts set-points in real-time in response to fast changing signals, such as building load, solar generation, or grid signals. In some aspects, the functionalities of the optimization and control manager 203 may be implemented, at least in part, within the cloud environment 104 (of FIG. 1). In certain aspects, the optimization and control manager 203 and/or other component(s) of the edge environment 102 may be used for performing a remote control functionality or logic (e.g., as a remote control system or as part of a remote control system), which is used for dynamically resetting an EVSE. Additional details regarding the remote control system are described herein with respect to, for example, FIGS. 6 and 7.

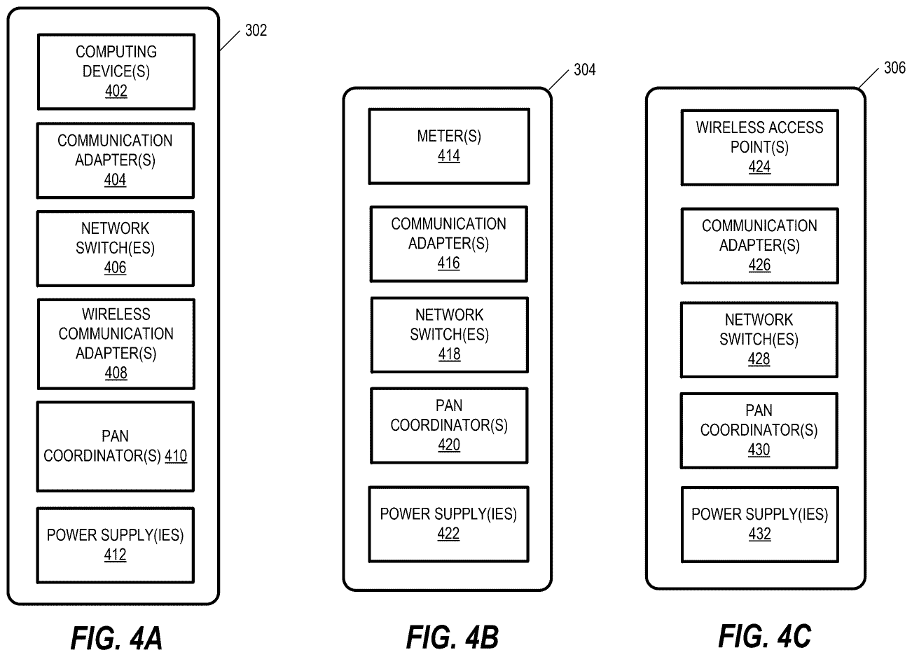

Hardware platform 226 represents any hardware for facilitating the processes and actions described herein. Specifically, one or more CPUs 230 may represent one or more types of processing device configured for executing instructions. One or more storage components 232 may be configured as long term storage, such as a hard drive or the like. One or more memory components 234 may include any of various types of random access memory or the like. One or more databases 228 may be configured for additional storage and may be housed with the other hardware and/or elsewhere. Examples of different hardware platforms that may be deployed in edge environment 102 are described further below with respect to FIGS. 4A-4C.

### Hardware Configurations for Edge Environment

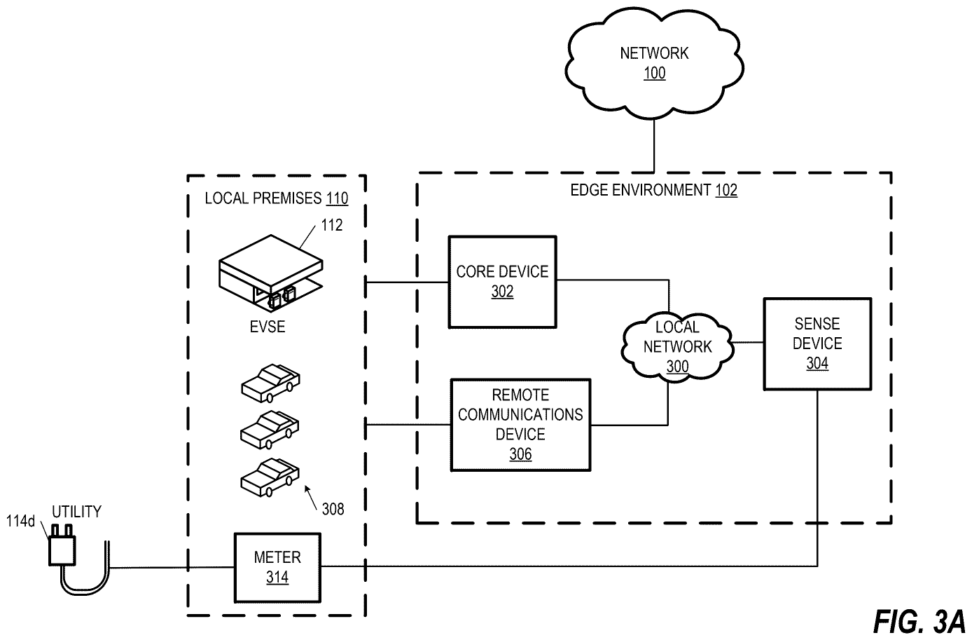

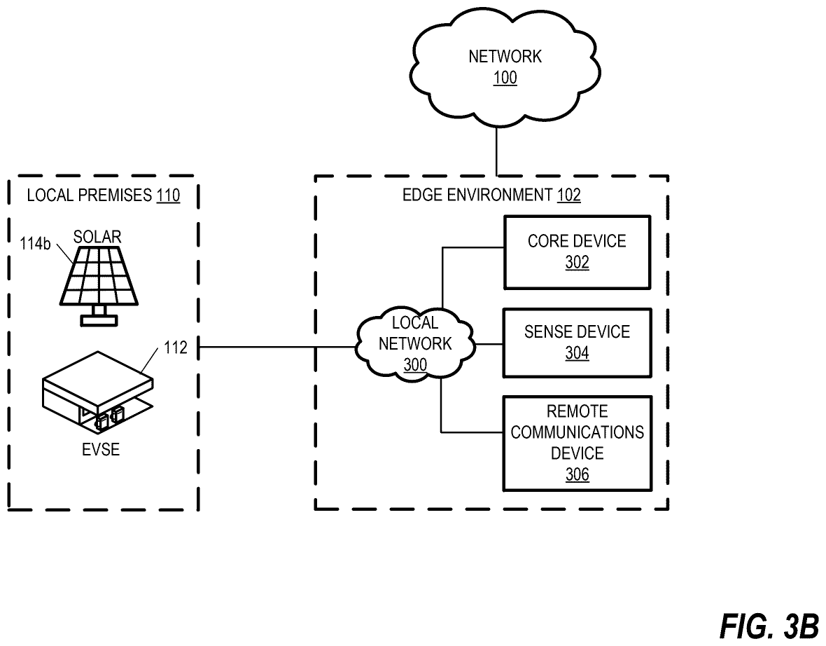

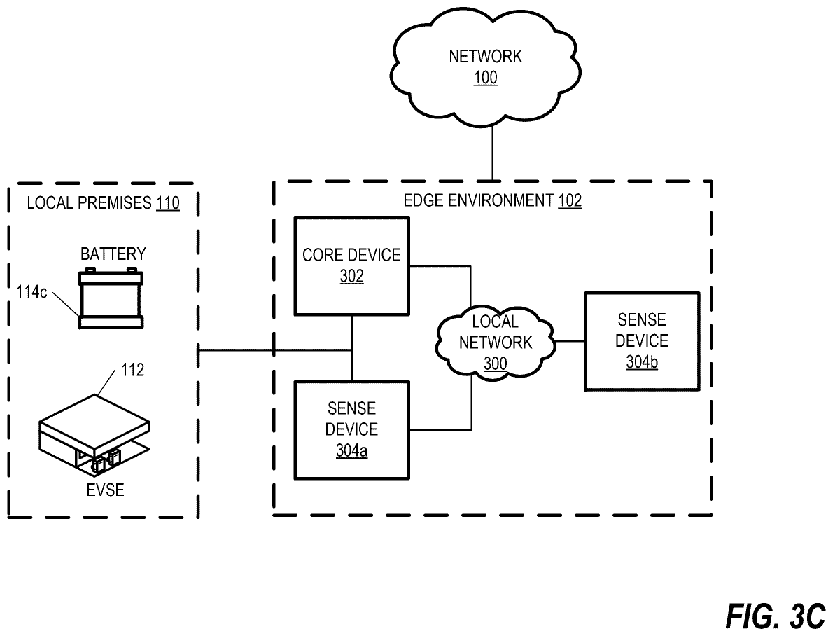

FIGS. 3A-3C depict example device configurations for edge environment 102, according to aspects provided herein. Specifically, FIG. 3A depicts a charging solution. As illustrated, the EVSE 112 is coupled to a local network 300 via a core device 302. The local network 300 may include any local area network, Ethernet, PAN, etc. The core device 302 may be physically installed within communications range of one or more chargers in the EVSE 112. A sense device 304 may be installed, for example, in an electrical room or in another enclosure with electrical equipment of the EVSE 112 and/or one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 (e.g., EVs) using EV chargers that are out of communications range of the core device 302, such as a sub-level of a parking garage, one or more remote communications devices 306 may be included. In certain aspects, at least one of the one or more remote communications devices 306 may be in data communication with the EVSE 112 (e.g., having one or more EV chargers charging one or more vehicles 308) and/or vehicles 308. Also included at the site 110 is a meter 314 for communicating energy with the utility grid 114d.

The core device 302 shown in FIG. 3A is the central processing device and serves as the communications hub. In certain aspects, the components of FIG. 2 may generally operate, at least in part, as part of the core device 302. The core device 302 may provide optimization, load management, communication coordination, and/or data historian services. The core device 302 may communicate with the cloud environment 104 via cellular modem, wired internet service provider (ISP), and/or other communications medium to get current optimization and load management set-points for EVSEs 112 and/or other assets, such as via an optimization algorithm that may be stored locally and/or at the cloud environment 104. It will be understood, however, that some aspects may be configured such that the core device 302 performs optimization locally. In certain aspects, the core device 302 dispatches these set-points, through a local communications protocol (e.g., Wi-Fi) and/or via the remote communications device 306 to reach locations that are distant or hard to reach, such as EVSEs with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single- and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single first sense device 304a can monitor the full site. In some cases where there is a significant distance to the metering point for the utility grid 114d, the second sense device 304b (or a plurality of second sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to aspects provided herein. Specifically, FIG. 4A depicts hardware components that may be present in core device 302. In some aspects, the core device 302 is the brain where the energy optimization and adaptive load management (ALM) functions (e.g., by the optimization and control manager 203 of FIG. 2) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some aspects, the computing device(s) 402 may include power line communication (PLC) infrastructure, while some aspects may utilize retail and/or micro-industrial computer components for optimization, load management, communication coordination, and/or historian services.

The communication adapter(s) 404 may be configured for load balancing and otherwise managing communications of Modbus RTU (RS485) to Modbus TCP (Ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a Zigbee coordinator, Bluetooth device, and/or other device for performing this function. The power supply(ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain aspects may be optimized for ease of installation and reduced intrusion to the site. Power over Ethernet (PoE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more meters 414, one or more communication adapters 416, one or more network switches 418, one or more PAN coordinators 420, and/or one or more power supplies 422. The power supply(ies) 422 may include a power interface for providing power to the sense device 304. In certain aspects, the meter(s) 414 may be power meter(s) utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via Zigbee, Bluetooth, and the like. In some aspects, PoE or other power source may be utilized.

As illustrated in FIG. 4C, the remote communications device 306 may be a network-connectivity extension, for example, for EV charging or solar monitoring locations where Zigbee, Wi-Fi, or Ethernet is being extended to remote or difficult-to-reach locations such as remote subpanels, parking garage levels, or rooftop inverters. Some aspects are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via Zigbee, Bluetooth, and the like. The power supply(ies) 432 may include a power interface for providing power to the remote communications device 306.

### Example Cloud Environment for Dynamic Evse Reset System

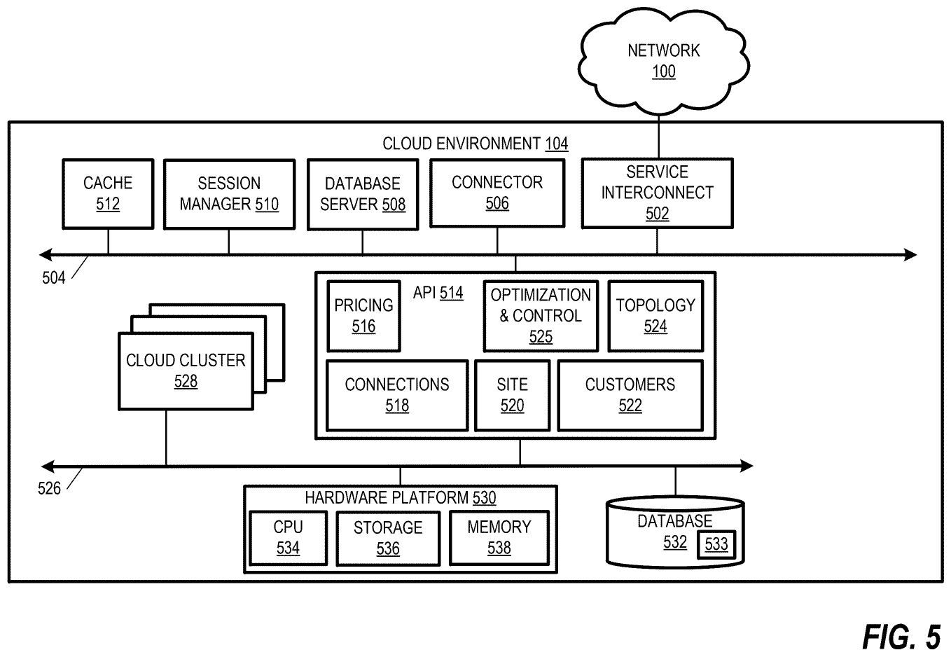

FIG. 5 depicts a cloud environment for a dynamic EVSE reset system, according to aspects provided herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an EVSE, such as EVSE 112, for the exchange of data between the edge environment 102 and the EVSE. For example, in some such aspects, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, and a collection of services and application programming interfaces (APIs) 514. The APIs 514 may include a pricing API 516, a connections API 518, a site API 520, a customers API 522, a topology API 524, and/or an optimization and control API 525. The APIs 514 may be implemented by hardware platform 530. Hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 is a component of the cloud environment 104. As such, the APIs 514 (including the pricing API 516, the connections API 518, the site API 520, the customers API 522, the topology API 524, and/or the optimization and control API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EVSE(s), for example, related to payment for energy usage. In some aspects, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain aspects, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some aspects, the optimization and control API 525 may be responsible for handling optimization requests, performing one or more optimization methods, and communicating the result of the optimization. For example, the optimization and control API 525 may be or include a service that may be executed when there is a newly connected or disconnected EVSE, such that an optimization may be performed to allocate (e.g., re-allocate) power according to updated state(s) of the EVSE(s). In some aspects, optimization and control API 525 may enable per-site configuration of the optimization and control parameters. For example, these parameters can be updated via API(s) 514 (e.g., optimization and control API 525) directly or via a front-end interface. These parameters may include different parameters for each optimization strategy as well as the grouping of strategies into stages. Moreover, optimization and control API 525 may be used to store (e.g., via database 532) input and output pairs (e.g., related to various optimization scenarios, where an input may correspond to a combination of the optimization configuration and system state and an output may correspond to a collection of parameters for how the system should operate, etc.) for subsequent analysis.

In certain aspects, the optimization and control API 525 and/or other component(s) of the cloud environment 104 may be used for performing a remote control functionality or logic (e.g., as a remote control system or as part of a remote control system), which is used for dynamically resetting an EVSE. Additional details regarding the remote control system are described herein with respect to, for example, FIGS. 6 and 7.

When a vehicle is plugged into an EVSE 112 (FIG. 1), the edge session broker 218 (FIG. 2) may communicate connection information to the APIs 514. The connection information may include vehicle information, user information, EVSE information, etc. The APIs 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain aspects, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

### Example of Dynamic EVSE Reset System

FIG. 6 depicts an example 600 of a dynamic EVSE reset system. The example 600 includes an EVSE 112 having a wireless communications module 602, a remote control system 604, and a wireless communications device 606. In certain aspects, the EVSE 112 has a reset circuitry 610 in which the wireless communications module 602 is embedded. Further in this example, the EVSE 112 includes a control circuitry 608 that is coupled to the reset circuitry 610. In certain aspects, the remote control system 604 may be implemented via one or more components of the edge environment 102 as depicted in and described with respect to FIG. 2, such as optimization and control manager 203. In certain aspects, the remote control system 604 may be implemented via one or more components of the cloud environment 104 as depicted in and described with respect to FIG. 5, such as optimization and control API 525. In certain aspects, the remote control system 604 may be implemented via a combination of one or more components of the edge environment 102 and one or more components of the cloud environment 104. Accordingly, the remote control system 604 may communicate with the EVSE 112 through a local network, such as the local network 300 shown in, for example, FIG. 3B, and/or the network 100 shown in, for example, FIG. 1. In certain aspects, the wireless communications device 606 may be on a mobile device 108c of FIG. 1.

As depicted, the EVSE 112 includes the control circuitry 608 within the EVSE 112. The control circuitry 608 controls the general functions of the EVSE 112, for example, to charge an EV. The control circuitry 608 may also be configured to reset the EVSE 112, such as by causing a power cycle of a power supply, or a reset of an operating system, or the like.

Furthermore, the EVSE 112 includes the reset circuitry 610. The reset circuitry 610 is coupled to the control circuitry 608. The reset circuitry 610 causes a reset of the EVSE 112 by activating a reset functionality of the control circuitry 608. In certain aspects, the reset circuitry 610 receives a reset signal from the wireless communications module 602 and causes the reset of the EVSE 112 based on the reset signal.

In certain aspects, the reset circuitry 610 includes the wireless communications module 602, where the wireless communications module 602 is embedded as part of the reset circuitry 610. The wireless communications module 602 receives a reset request from a remote wireless communications device, such as the wireless communications device 606, which may be on a user device, such as a mobile device 108c of FIG. 1. The reset signal sent by the wireless communications module 602 to the reset circuitry 610 to cause the reset of the EVSE 112 may be based on the reset request from the wireless communications device 606. In certain aspects, the reset request may include an indication of an authenticated user. For example, the reset request may include configured data that includes user credentials based on or relating to, for example, a user device, such as a device identifying information or a wireless communications device identifying information (e.g., Bluetooth Address, Media Access Control (MAC) address, International Mobile Equipment Identity (IMEI), or other unique identifiers). In other examples, the reset request may include configured data that indicates that a user requesting a reset of the EVSE 112 is an authenticated user, such as in a configured or defined field or portion of the data included in the reset request. For example, the data included in the configured or defined field or portion may include an indication of a successful authentication of the user. In some aspects, such configured or defined field or portion may include a type of code or Personal Identification Number (PIN) that may be used by, for example, the reset circuitry 610 to cause the reset of the EVSE 112. For example, the type of code or PIN may be a time-varying code for added security for the reset of the EVSE 112. In certain aspects, the user may be authenticated for resetting the EVSE 112 based on an authentication of the user for charging an EV. In some aspects, the user may be authenticated via the remote control system 604 by, for example, entering additional credentials (e.g., a username and a password, etc.) that further authenticate the user for resetting the EVSE 112. Upon successful authentication, the remote control system 604 may provide data, such as an indication of a successful authentication, to be added to the reset request to be sent from a user device to the EVSE 112. The reset request may be sent by the wireless communications device 606 on the user device. The wireless communications device 606 may communicate with the wireless communications module 602 on the EVSE 112. Examples of the wireless communications module 602 include, but are not limited to: radio frequency identification (RFID), Bluetooth, or Near Field Communication (NFC) modules. Additionally, examples of the wireless communications device 606 include, but are not limited to: RFID, Bluetooth, or NFC devices. In certain aspects, the wireless communications module 602 and the wireless communications device 606 may be modules and devices using other known wireless protocols or technology, such as Zigbee, Wi-Fi, or the like.

FIG. 7 depicts another example 700 of a dynamic EVSE reset system. Similar to the example 600 of FIG. 6, the example 700 includes an EVSE 112 having a wireless communications module 602, a remote control system 604, and a wireless communications device 606, as well as a control circuitry 608. In certain aspects, the EVSE 112 has a reset circuitry 710 that is coupled to the wireless communications module 602.

The reset circuitry 710 causes a reset of the EVSE 112 by activating a reset functionality of the control circuitry 608. In certain aspects, the reset circuitry 710 receives a reset signal from the wireless communications module 602 and causes the reset of the EVSE 112 based on the reset signal. In certain aspects, the wireless communications module 602 includes a set of general purpose input/output (GPIO) pins 702, and the reset circuitry 710 includes a set of GPIO pins 704. In the depicted example 700, the reset circuitry 710 are coupled to the wireless communications module 602 by one or more of the GPIO pins 704 on the reset circuitry 710 and one or more of the GPIO pins 702 on the wireless communications module 602. For example, a first GPIO pin 702a on the wireless communications module 602 is connected to a first GPIO pin 704a on the reset circuitry 710 by a first connection 706. A second GPIO pin 702b on the wireless communications module 602 is connected to a second GPIO pin 704b on the reset circuitry 710 by a second connection 708. For example, the first GPIO pins 702a and 704a may be configured as ground pins, and the second GPIO pins 702b and 704b may be configured for communicating a reset signal. In certain aspects, the wireless communications module 602 may receive a reset request from a remote wireless communications device, such as a mobile device 108c of FIG. 1, and send the reset signal to the reset circuitry 710 to cause the reset of the EVSE 112. Accordingly, the reset signal may be based on the reset request. In certain aspects, the reset request may include an indication of an authenticated user for resetting the EVSE 112, as described with respect to FIG. 6. In certain aspects, the GPIO pins 704 may be available on a Printed Circuit Board (PCB) of the reset circuitry 710. In certain aspects, the GPIO pins 704 may be connected to a reset point on the PCB of the reset circuitry 710. It should be understood that while certain aspects have been described with the GPIO pins as a type of electrical interconnect between the reset circuitry 710 and the wireless communications module 602, the GPIO pins are one well-known type of electrical interconnect, and any other type of electrical interconnect may be used, such as other types of buses or connections. Moreover, the GPIO pins as described herein may allow the wireless communications module 602 to be retrofitted to an existing EVSE.

### Example Process Flow of Dynamic EVSE Reset System

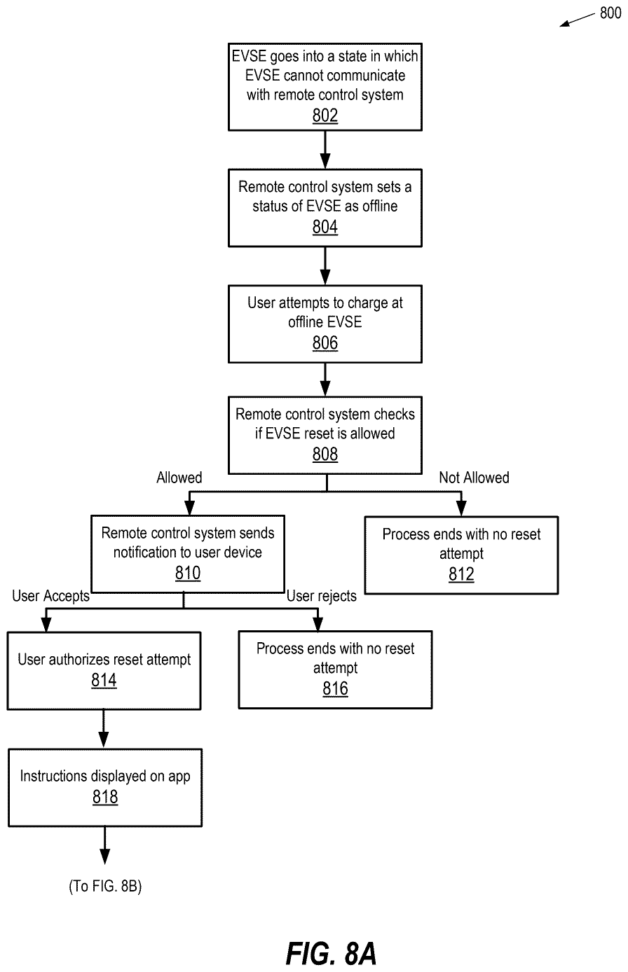

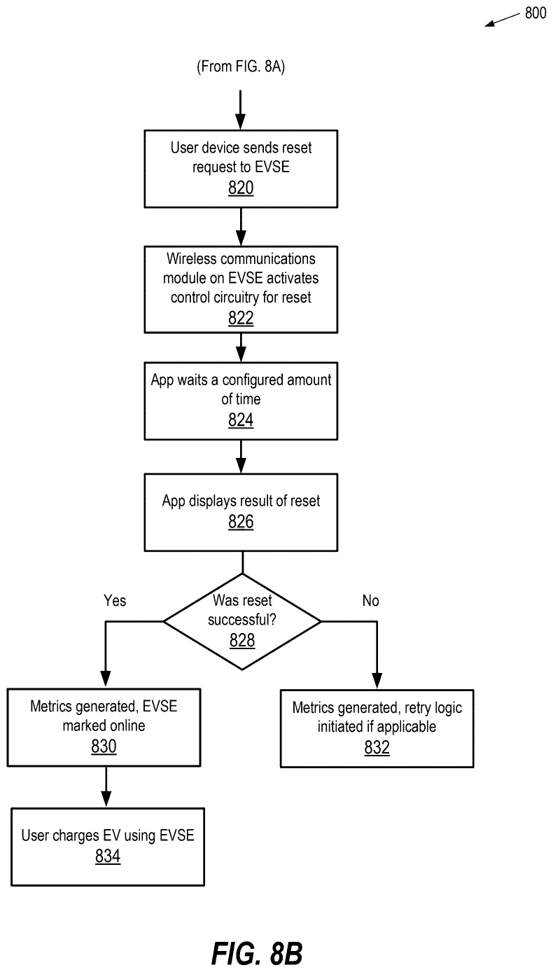

FIGS. 8A and 8B depict an example process flow 800 for a dynamic EVSE reset system. The example process flow 800 includes parts performed by the EVSE 112, the remote control system 604, and a user device including the wireless communications device 606, as depicted in FIGS. 6 and 7.

As the example process flow 800 shows, the remote control system 604 monitors the status of one or more EVSEs, such as the EVSE 112. In some aspects, the remote control system 604 stores a determined status of an EVSE, such that when a user attempts to charge an EV by an offline or faulting EVSE, the remote control system 604 can logically determine if the user should be prompted for resetting the EVSE. The offline or faulting status of the EVSE may refer to a status in which the EVSE is not communicating with the remote control system 604 or has some other fault preventing nominal operation. Such status of the EVSE may be compared (by the remote control system 604) against a list of known offline or fault statuses in which the EVSE is not able to communicate with the remote control system 604 and/or otherwise in which the EVSE is not able to charge an EV, but where the EVSE can be reset. For example, the remote control system 604 may prompt a user for resetting the EVSE based on a reset condition being satisfied, where the reset condition may include one or more of (1) the EVSE having a known offline or fault status that can be cleared by a reset, (2) the EVSE not having performed an unsuccessful reset attempt, or (3) the EVSE not having a status set to indicate that a technician has already been contacted (and thus no reset is needed). Any reset attempt and its result may be stored on the remote control system 604, such that remote control system 604 can evaluate the reset condition for prompting a user to reset the EVSE. In certain aspects, the EVSE includes a control circuitry that acts as an interface to reset the EVSE (including its various control modules) based on a reset signal from a reset circuitry, as described herein with respect to FIGS. 6 and 7.

In certain aspects, the remote control system 604 receives real-time status update from EVSEs, where the remote control system 604 may determine that a connection with an EVSE has been lost when the remote control system 604 does not receive any status update from the EVSE for a configured amount of time. The remote control system 604 may then process diagnostic signals related to a current status of the EVSE to determine whether a reset of the EVSE may be needed and/or allowed. If the reset of the EVSE is needed and allowed, the remote control system 604 may send a notification (e.g., a push notification) to a user device to prompt a user to attempt a reset of the EVSE. In certain aspects, the user device (with a mobile app running on the user device) may provide a user interface for the user, to display the notification from the remote control system 604 to prompt the user regarding whether the user is willing to allow the user device to be used to reset an EVSE. Additionally, the instructions on how to attempt the reset of the EVSE may be displayed via the user interface. The user device may receive such notifications from the remote control system 604, and send a reset request to the EVSE upon user authentication.

Referring now to FIG. 8A, at 802, an EVSE goes into a state in which the EVSE cannot communicate with a remote control system, or has another fault that is not recoverable through autonomous action of the EVSE. For example, the EVSE may go into one of a list of known fault statuses or offline states in which the EVSE cannot communicate with the remote control system but can be reset to go back to an online status or state, or into one of other statuses or states in which the EVSE cannot communicate with the remote control system and it is unknown whether a reset may bring the EVSE back into an online status or state.

At 804, the remote control system sets a status of the EVSE as being offline or in any other status in which the remote control system cannot communicate with the EVSE. The status may be set as a flag, and the EVSE with such status may be referred to as an offline EVSE. In certain aspects, the EVSE may indicate such status in various ways, such as status lights, messages on a graphical user interface (GUI), etc.

At 806, a user attempts to charge at the offline EVSE. In certain aspects, the user may send a request to charge an EV using the offline EVSE by, for example, sending the request via a mobile app running on a user device, scanning a code (e.g., a QR code) on the offline EVSE, etc.

At 808, the remote control system checks if a reset is allowed for the offline EVSE. For example, the remote control system may determine whether the reset is allowed by processing one or more diagnostic logs. Particularly, the remote control system may determine whether the reset is allowed based on a reset condition being satisfied, as described further herein. For example, the remote control system may determine that the reset is allowed when the remote control system determines that the EVSE has a known offline or fault status that can be cleared by a reset, since the reset may immediately bring the EVSE having such status back to an online status without extending the service interruption any further. In another example, the remote control system may determine that the reset is not allowed when the remote control system determines that the EVSE has previously performed an unsuccessful reset attempt after having gone into an offline or fault status, since any subsequent reset attempt may be an unwanted repeated reset attempt (that does not result in bringing the EVSE back online and thus unnecessarily uses the resources of, for example, the remote control system). In yet another example, the remote control system may determine that the reset is not allowed when the remote control system determines that the EVSE has a status set to indicate that a technician has already been contacted, since resetting the EVSE in this case may alter the status of the EVSE known to the technician, potentially prolonging the service interruption unnecessarily. Various combinations of the above types of determinations may be used for determining whether the reset condition has been satisfied.

At 810, if the reset of the EVSE is determined to be allowed based on, for example, the reset condition being satisfied, the remote control system sends a notification to the user device to prompt a user for authorization to attempt a reset of the offline EVSE. Here, the authorization to attempt the reset of the offline EVSE may refer to a request from the remote control system to the user to use the user device to attempt the reset of the offline EVSE.

At 812, if the reset of the EVSE is determined to not be allowed based on, for example, the reset condition not being satisfied, the process ends with no reset attempt.

At 814, if the user accepts the authorization request, the user may make a selection on the user interface of the user device to accept the authorization request.

At 816, if the user rejects the authorization request (and makes such selection on the user interface of the user device), the process ends with no reset attempt. In certain aspects, the user device may display another notification regarding another EVSE to use for charging an EV and any related information, such as its location, etc.

At 818, one or more instructions regarding how to reset the offline EVSE are displayed on the user interface of the user device via a mobile app running on the user device. In certain aspects, the instructions may be text-based and/or shown as an image or a video, etc. For example, the instructions may describe or portray where to place the user device in order to cause the reset of the EVSE.

Referring now to FIG. 8B, at 820, the user device sends a reset request to the offline EVSE. In certain aspects, the reset request may be or include a command to cause the reset of the EVSE. For example, the user may bring the user device (having a wireless communications device thereon) within a certain proximity of the offline EVSE. Specifically, the user device may be brought within a known distance (that allows, for example, a Bluetooth or NFC communication to occur) from where a wireless communications module is installed on the offline EVSE to allow the reset request or command to be sent to the offline EVSE by a wireless communication, such as via RFID, Bluetooth, or NFC technology. Other possible wireless communications technology may include Wi-Fi or Zigbee. The instructions from block 818 may include the information or instruction(s) regarding bringing the user device within a certain proximity of the offline EVSE and/or regarding where on the offline EVSE to place the user device to send the reset request.

At 822, the wireless communications module on the offline EVSE activates a reset functionality on the control circuitry of the offline EVSE for reset of the offline EVSE. For example, the wireless communications module may send a reset signal based on a valid reset request being received from the wireless communications device of the user device, where the valid reset request may be received based on a successful authentication of the requesting user. In certain aspects, the valid reset request may include an indication of the successfully authenticated user. In some aspects, the valid reset request may (e.g., only) be received and processed by the wireless communications module on the offline EVSE based on a match of known identifiers that are authenticated (e.g., where the reset request is sent to a known Bluetooth address of the wireless communications module of the offline EVSE and/or from a known Bluetooth address of the wireless communications device of the user device, etc.)

At 824, the mobile app on the user device waits a configured amount of time. For example, this configured amount of time may correspond to a threshold maximum amount of time that the mobile app (or the remote control system) may wait before determining that the communication between the EVSE and the remote control system is still lost after the reset.

At 826, the mobile app displays the result of the reset attempt by the user interface on the user device. For example, the result may be that the reset was successful based on the remote control system determining that the reset was successful (at 828) after receiving a valid status update from the EVSE and sending an indication of the successful reset to the user device. In another example, the result may be that the reset was unsuccessful based on the remote control system determining that the reset was not successful (at 828) after receiving an indication of an unsuccessful reset from the EVSE (e.g., where the EVSE has been reset and the communication between the EVSE and the remote control system has been restored, but the EVSE still cannot charge an EV, etc.) or not receiving any status update from the EVSE for the threshold maximum amount of time.

At 830, based on a successful reset, the remote control system generates one or more metrics relating to the successful reset of the EVSE (e.g., including any prior/cleared fault/offline status or state, timestamps for start and end of the reset, the result of the reset, etc.). Additionally, the remote control system sets a status of the EVSE to indicate that EVSE is now back online (e.g., able to communicate with the remote control system and charge an EV).

At 832, based on an unsuccessful reset, the remote control system generates one or more metrics relating to the unsuccessful reset of the EVSE (e.g., including any prior fault/offline status or state, timestamps for start and end of the reset, the result of the reset, etc.). Additionally, the remote control system may initiate a retry logic to attempt another reset (e.g., automatically). For example, if the result of the reset was that the EVSE is now able to communicate with the remote control system but still cannot charge an EV, the EVSE may automatically send another reset request to the EVSE to try another reset. In another example, if the result of the reset was that no status was received from the EVSE for a certain amount of time, the EVSE may send another notification to a user device to prompt the user to try the reset if the reset has not been attempted yet. Other retry logics may also be possible.

At 834, the user charges an EV using the EVSE.

As described above, a reset of an offline EVSE may be performed based on the example process flow 800. The example process flow 800 efficiently and safely attempts a reset of the EVSE (e.g., without having to wait for any qualified electrician or knowledgeable technician to be contacted or having to flip a breaker, etc.). The example process flow 800 reduces a service interruption due to an offline EVSE by either successfully resetting the EVSE or by reducing any potential troubleshooting to be performed based on the virtue of having performed a reset as an initial measure and generating additional information (relating to the reset attempt) that is helpful for the additional troubleshooting. Accordingly, the example process flow 800 can cut down the downtime of the offline EVSE attributable to the troubleshooting and shorten the overall service interruption. For example, the example process flow 800 allows any authenticated user to act as a field technician to attempt a reset of an offline EVSE.

### Example Method of Dynamic EVSE Reset System

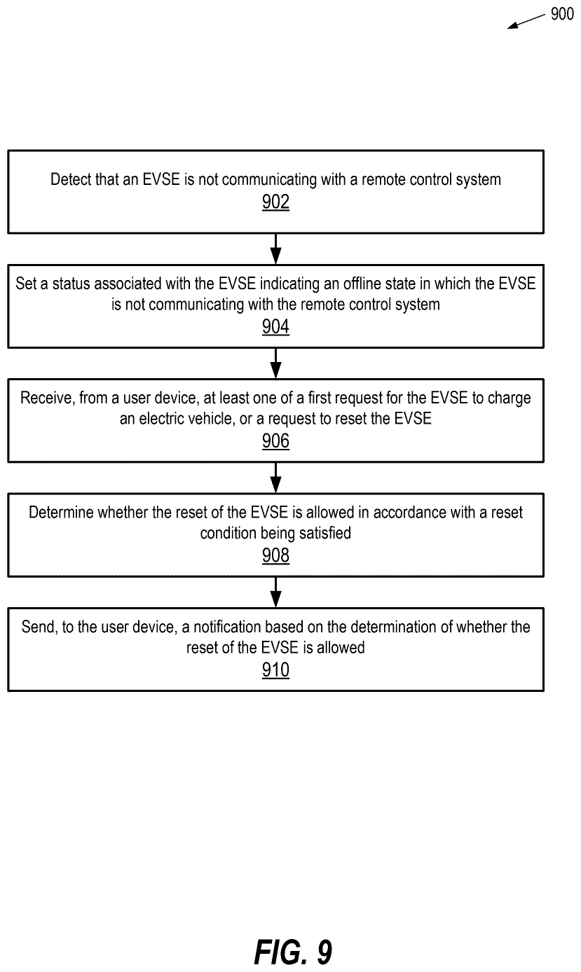

FIG. 9 depicts an example method 900 performed by a remote control system of an EVSE as part of a dynamic EVSE reset system. The method 900 may be performed by the remote control system 604 of FIG. 6. For example, the method 900 may be performed by a core device 302 of FIG. 3, for example, by utilizing one or more components of edge environment 102 described herein with respect to FIG. 2 and/or one or more components of cloud environment 104 described herein with respect to FIG. 5. Various steps of the example method 900 correspond to certain respective parts of the example process flow 800 of FIGS. 8A and 8B.

At 902, the method 900 starts with detecting that an EVSE is not communicating with a remote control system. In some aspects, the EVSE not communicating with the remote control system may be an example of the state of EVSE described with respect to 802 of FIG. 8A.

At 904, the method 900 proceeds with setting a status associated with the EVSE indicating an offline state in which the EVSE is not communicating with the remote control system. In some aspects, setting the status associated with the EVSE indicating an offline state in which the EVSE is not communicating with the remote control system may be an example of the remote control system setting a status of the EVSE as being offline or in any other status in which the remote control system cannot communicate with the EVSE, described with respect to 804 of FIG. 8A.

At 906, the method 900 proceeds with receiving, from a user device, at least one of a first request for the EVSE to charge an electric vehicle, or a request to reset the EVSE. In some aspects, receiving at least one of the first request for the EVSE to charge an electric vehicle or the request to reset the EVSE may be an example of a user attempting to charge at an offline EVSE, described with respect to 806 of FIG. 8A.

At 908, the method 900 proceeds with determining whether the reset of the EVSE is allowed in accordance with a reset condition being satisfied. In some aspects, determining whether the reset of the EVSE is allowed may be an example of the remote control system checking if a reset is allowed for the offline EVSE, described with respect to 808 of FIG. 8A.

At 910, the method 900 proceeds with sending, to the user device, a notification based on the determination of whether the reset of the EVSE is allowed. In some aspects, sending the notification based on the determination of whether the reset of the EVSE is allowed may be an example of the remote control system sending a notification to the user device, described with respect to 810 of FIG. 8A.

In certain aspects, detecting that the EVSE is not communicating with the remote control system includes determining that no status update has been received from the EVSE for at least a threshold amount of time.

In certain aspects, satisfying the reset condition includes at least one of: receiving, from the EVSE, a fault status that can be cleared by the reset of the EVSE; determining that there is no indication of an unsuccessful reset of the EVSE after detecting that the EVSE is not communicating with the remote control system; or determining, based on another status associated with the EVSE, that no technician has been contacted for servicing of the EVSE after detecting that the EVSE is not communicating with the remote control system.

In certain aspects, the method 900 further includes determining whether the reset condition is satisfied by analyzing one or more diagnostic signals.

In certain aspects, determining whether the reset of the EVSE is allowed includes determining that the reset of the EVSE is allowed, and sending the notification includes sending an authorization request to perform the reset of the EVSE.

In certain aspects, the method 900 further includes: receiving, from the user device, an acceptance of the authorization request to perform the reset of the EVSE; and sending, to the user device, an instruction for performing the reset of the EVSE.

In certain aspects, the method 900 further includes determining a result of the reset of the EVSE.

In certain aspects, determining the result of the reset of the EVSE includes receiving, from the EVSE, an indication of a successful reset of the EVSE, and the method 900 further includes sending, to the user device, the indication of the successful reset of the EVSE and an instruction for a user to proceed with charging the electric vehicle using the EVSE.

In certain aspects, the method 900 further includes: generating a log including one or more metrics related to the successful reset of the EVSE; modifying the status associated with the EVSE based on the indication of the successful reset of the EVSE, the modified status indicating an online state in which the EVSE is communicating with the remote control system; receiving, from the user device, a second request for the EVSE to charge the electric vehicle; and sending, to the EVSE, an instruction to charge the electric vehicle.

In certain aspects, determining the result of the reset of the EVSE includes: determining that the reset of the EVSE was unsuccessful based on receiving no status update regarding the result of the reset of the EVSE for at least a threshold amount of time, and the method 900 further includes: generating a log including one or more metrics related to the unsuccessful reset of the EVSE; maintaining the status associated with the EVSE based on determining that the reset of the EVSE was unsuccessful; and sending, to the user device, an indication of the unsuccessful reset of the EVSE including (i) a recommendation to use another EVSE to charge the electric vehicle, and (ii) information related to the other EVSE.

In certain aspects, determining whether the reset of the EVSE is allowed includes determining that the reset of the EVSE is not allowed, and sending the notification includes sending an indication that the reset of the EVSE is not allowed, where the notification includes (i) a recommendation to use another EVSE to charge the electric vehicle, and (ii) information related to the other EVSE.

The method 900 provides a technical solution for dynamically resetting an EVSE that allows authenticated users to perform a reset when the EVSE is offline (e.g., unable to communicate with a remote control system). The solution provided by the method 900 provides a controlled and secure reset capability for an EVSE, which reduces service interruption by enabling the dynamic reset of the EVSE without having to contact a qualified electrician or a knowledgeable technician or having to flip a breaker.

Note that FIG. 9 is just one example of a method, and other methods including fewer, additional, or alternative operations are possible consistent with this disclosure.

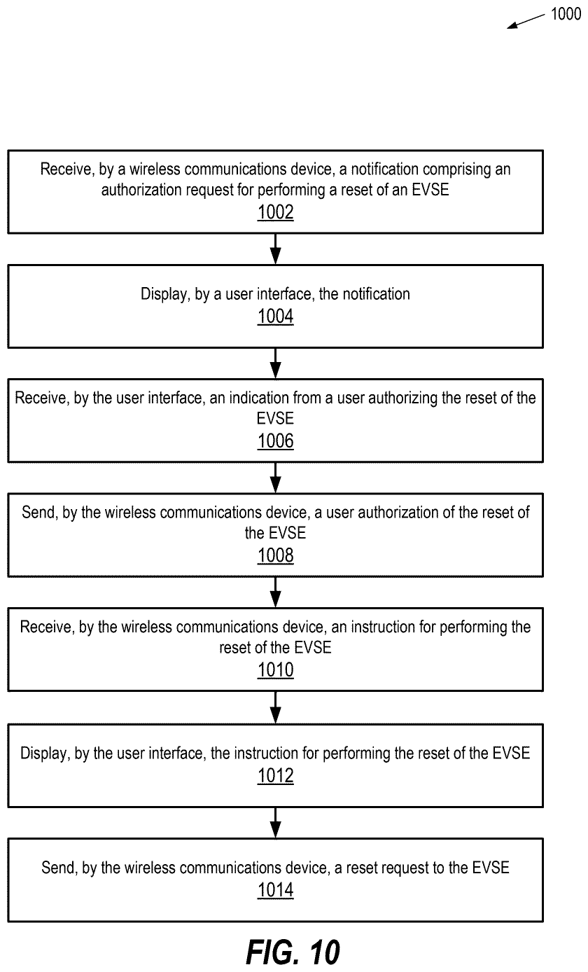

FIG. 10 depicts an example method 1000 performed by a user device as part of a dynamic EVSE reset system. The method 1000 may be performed by a user device, such as a mobile device 108c of FIG. 1, where the user device may have a user interface, run a mobile app, and/or include the wireless communications device 606 described herein with respect to FIGS. 6 and 7. Various steps of the example method 1000 correspond to certain respective parts of the example process flow 800 of FIGS. 8A and 8B.

At 1002, the method 1000 starts with receiving, by a wireless communications device, a notification including an authorization request for performing a reset of an EVSE. In some aspects, receiving the notification including an authorization request for performing a reset of an EVSE may correspond to the remote control system sending a notification to the user device, described with respect to 810 of FIG. 8A.

At 1004, the method 1000 proceeds with displaying, by a user interface, the notification. In some aspects, displaying the notification may correspond to displaying the notification from remote control system 604 to prompt a user regarding whether the user is willing to allow a user device to be used to reset an EVSE, described with respect to example process flow 800 of FIGS. 8A and 8B.

At 1006, the method 1000 proceeds with receiving, by the user interface, an indication from a user authorizing the reset of the EVSE. In some aspects, receiving the indication from the user authorizing the reset of the EVSE may correspond to the user making a selection on the user interface of a user device to accept an authorization request, described with respect to 814 of FIG. 8A.

At 1008, the method 1000 proceeds with sending, by the wireless communications device, a user authorization of the reset of the EVSE. In some aspects, sending the user authorization may be based on the user making a selection on the user interface of a user device to accept an authorization request, described with respect to 814 of FIG. 8A.

At 1010, the method 1000 proceeds with receiving, by the wireless communications device, an instruction for performing the reset of the EVSE. In some aspects, receiving the instruction for performing the reset of the EVSE may be based on the user making a selection on the user interface of a user device to accept an authorization request, described with respect to 814 of FIG. 8A, and may result in one or more instructions regarding how to reset the offline EVSE being displayed on the user interface of a user device via a mobile app running on the user device, described with respect to 818 of FIG. 8A.

At 1012, the method 1000 proceeds with displaying, by the user interface, the instruction for performing the reset of the EVSE. In some aspects, displaying the instruction for performing the reset of the EVSE may correspond to one or more instructions regarding how to reset the offline EVSE being displayed on the user interface of a user device via a mobile app running on the user device, described with respect to 818 of FIG. 8A.

At 1014, the method 1000 proceeds with sending, by the wireless communications device, a reset request to the EVSE. In some aspects, sending the reset request to the EVSE may correspond to a user device sending a reset request to an offline EVSE, described with respect to 820 of FIG. 8B.

In certain aspects, the method 1000 further includes: sending, by the wireless communications device, a request for the EVSE to charge an electric vehicle, wherein the notification is responsive to the request for the EVSE to charge the electric vehicle.

In certain aspects, the method 1000 further includes: sending, by the wireless communications device, an indication of at least one of: (i) the EVSE being unable to charge an electric vehicle, or (ii) the EVSE needing to be reset, where the notification is responsive to the indication of the at least one of: (i) the EVSE being unable to charge the electric vehicle, or (ii) the EVSE needing to be reset.

In certain aspects, the method 1000 further includes: receiving, by the wireless communications device, a result of the reset of the EVSE; and displaying, by the user interface, the result.

In certain aspects, the result of the reset of the EVSE includes an indication of a successful reset of the EVSE, and the method 1000 further includes displaying, by the user interface, an indication for the user to proceed with charging an electric vehicle using the EVSE.

In certain aspects, the result of the reset of the EVSE includes an indication of an unsuccessful reset of the EVSE, and the method 1000 further includes displaying, by the user interface, an indication including one or more of: (i) a recommendation to use another EVSE to charge an electric vehicle, or (ii) information related to the other EVSE.

The method 1000 provides a technical solution for dynamically resetting an EVSE that allows authenticated users to perform a reset of an offline EVSE. The solution provided by the method 1000 combines an integration of the remote control system and a user device running a mobile app with sending a reset request via a wireless technology using, for example, a hardware module installed on or within the EVSE.

Note that FIG. 10 is just one example of a method, and other methods including fewer, additional, or alternative operations are possible consistent with this disclosure.

### Example Processing System for Dynamic EVSE Reset System

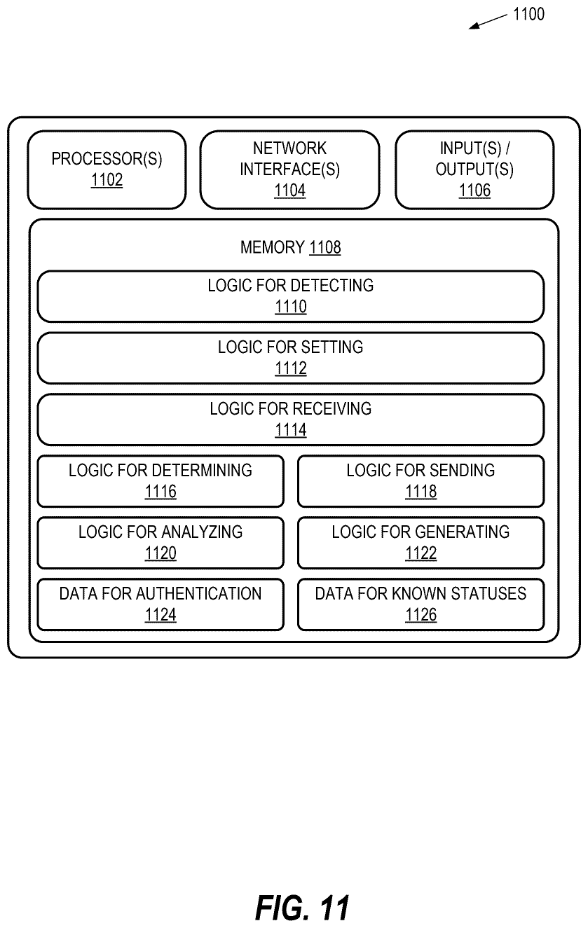

FIG. 11 depicts an example processing system 1100 configured to perform the method 900 described herein. In some aspects, example processing system 1100 may be an example of the remote control system 604 of FIG. 6 or the core device 302 of FIG. 3, for example, including one or more components of edge environment 102 described herein with respect to FIG. 2 and/or one or more components of cloud environment 104 described herein with respect to FIG. 5.

Processing system 1100 includes one or more processors 1102. Generally, the one or more processors 1102 may be configured to execute computer-executable instructions (e.g., software code) to perform various functions, as described herein.

Processing system 1100 further includes one or more network interfaces 1104, which generally provide data access to any sort of data network, including personal area networks (PANs), local area networks (LANs), wide area networks (WANs), the internet, and the like.

Moreover, processing system 1100 includes input(s) and output(s) 1106, which generally provide means for providing data to and from processing system 1100, such as via connection to computing device peripherals, including user interface peripherals.

Processing system 1100 also includes one or more memories 1108 including various components. In this example, the one or more memories 1108 includes a logic for detecting 1110, a logic for setting 1112, a logic for receiving 1114, a logic for determining 1116, a logic for sending 1118, a logic for analyzing 1120, and a logic for generating 1122. Additionally, the one or more memories 1108 includes data for authentication 1124 and data for known statuses 1126.

Processing system 1100 may be implemented in various ways. For example, processing system 1100 may be implemented as a computing device 402 within a core device 302, described herein with respect to FIGS. 3 and 4. In various aspects, one or more aspects may be omitted from, added to, or substituted from processing system 1100.

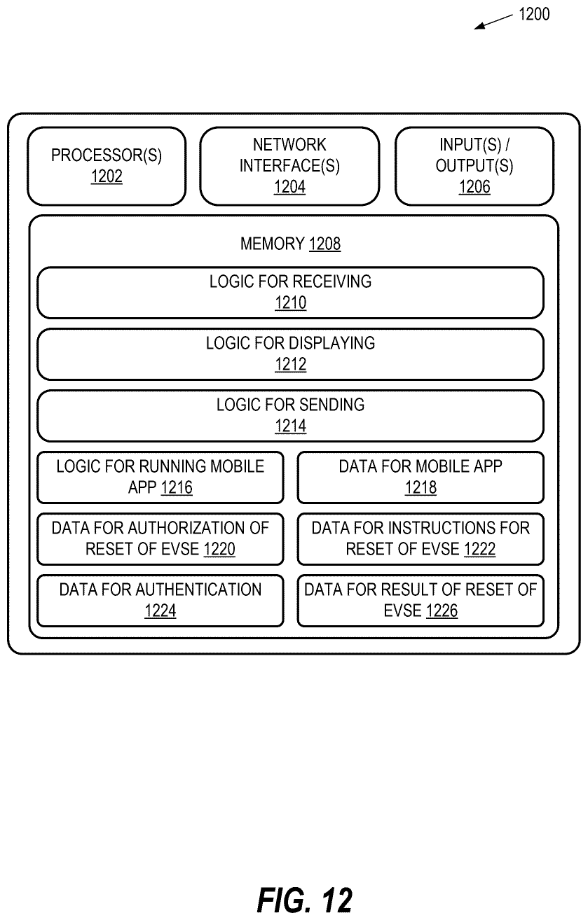

FIG. 12 depicts an example processing system 1200 configured to perform the method 1000 described herein. In some aspects, example processing system 1200 may be an example of a user device, such as a mobile device 108c of FIG. 1, having a user interface, running a mobile app, and/or including the wireless communications device 606 described herein with respect to FIGS. 6 and 7.

Processing system 1200 includes one or more processors 1202. Generally, the one or more processors 1202 may be configured to execute computer-executable instructions (e.g., software code) to perform various functions, as described herein.

Processing system 1200 further includes one or more network interfaces 1204, which generally provide data access to any sort of data network, including personal area networks (PANs), local area networks (LANs), wide area networks (WANs), the internet, and the like.

Moreover, processing system 1200 includes input(s) and output(s) 1206, which generally provide means for providing data to and from processing system 1200, such as via connection to computing device peripherals, including user interface peripherals.

Processing system 1200 also includes one or more memories 1208 including various components. In this example, the one or more memories 1208 includes a logic for receiving 1210, a logic for displaying 1212, a logic for sending 1214, and a logic for running a mobile app 1216. Additionally, the one or more memories 1208 includes data for the mobile app 1218, data for authorization of the reset of an EVSE 1220, data for instructions for the reset of the EVSE 1222, data for authentication 1224, and data for a result of the reset of the EVSE 1226.

Processing system 1200 may be implemented in various ways. For example, processing system 1200 may be implemented as a mobile device 108c, described herein with respect to FIG. 1. In various aspects, one or more aspects may be omitted from, added to, or substituted from processing system 1200.

### Example Clauses

Implementation examples are described in the following numbered clauses:

Clause 1: A method, comprising: detecting that an electric vehicle supply equipment (EVSE) is not communicating with a remote control system; setting a status associated with the EVSE indicating an offline state in which the EVSE is not communicating with the remote control system; receiving, from a user device, at least one of a first request for the EVSE to charge an electric vehicle, or a request to reset the EVSE; determining whether the reset of the EVSE is allowed in accordance with a reset condition being satisfied; and sending, to the user device, a notification based on the determination of whether the reset of the EVSE is allowed.

Clause 2: The method in accordance with Clause 1, wherein detecting that the EVSE is not communicating with the remote control system comprises determining that no status update has been received from the EVSE for at least a threshold amount of time.

Clause 3: The method in accordance with any one of Clauses 1-2, wherein: satisfying the reset condition comprises at least one of: receiving, from the EVSE, a fault status that can be cleared by the reset of the EVSE; determining that there is no indication of an unsuccessful reset of the EVSE after detecting that the EVSE is not communicating with the remote control system; or determining, based on another status associated with the EVSE, that no technician has been contacted for servicing of the EVSE after detecting that the EVSE is not communicating with the remote control system.

Clause 4: The method in accordance with any one of Clauses 1-3, further comprising determining whether the reset condition is satisfied by analyzing one or more diagnostic signals.

Clause 5: The method in accordance with any one of Clauses 1-4, wherein: determining whether the reset of the EVSE is allowed comprises determining that the reset of the EVSE is allowed, and sending the notification comprises sending an authorization request to perform the reset of the EVSE.

Clause 6: The method in accordance with Clause 5, further comprising: receiving, from the user device, an acceptance of the authorization request to perform the reset of the EVSE; and sending, to the user device, an instruction for performing the reset of the EVSE.

Clause 7: The method in accordance with Clause 6, further comprising determining a result of the reset of the EVSE.

Clause 8: The method in accordance with Clause 7, wherein: determining the result of the reset of the EVSE comprises receiving, from the EVSE, an indication of a successful reset of the EVSE, and the method further comprises sending, to the user device, the indication of the successful reset of the EVSE and an instruction for a user to proceed with charging the electric vehicle using the EVSE.

Clause 9: The method in accordance with Clause 8, further comprising: generating a log comprising one or more metrics related to the successful reset of the EVSE; modifying the status associated with the EVSE based on the indication of the successful reset of the EVSE, the modified status indicating an online state in which the EVSE is communicating with the remote control system; receiving, from the user device, a second request for the EVSE to charge the electric vehicle; and sending, to the EVSE, an instruction to charge the electric vehicle.

Clause 10: The method in accordance with any one of Clauses 7-9, wherein determining the result of the reset of the EVSE comprises: determining that the reset of the EVSE was unsuccessful based on receiving no status update regarding the result of the reset of the EVSE for at least a threshold amount of time, and the method further comprises: generating a log comprising one or more metrics related to the unsuccessful reset of the EVSE; maintaining the status associated with the EVSE based on determining that the reset of the EVSE was unsuccessful; and sending, to the user device, an indication of the unsuccessful reset of the EVSE comprising (i) a recommendation to use another EVSE to charge the electric vehicle, and (ii) information related to the other EVSE.

Clause 11: The method in accordance with Clauses 1-10, wherein: determining whether the reset of the EVSE is allowed comprises determining that the reset of the EVSE is not allowed, and sending the notification comprises sending an indication that the reset of the EVSE is not allowed, the notification comprising (i) a recommendation to use another EVSE to charge the electric vehicle, and (ii) information related to the other EVSE.

Clause 12: A method, comprising: receiving, by a wireless communications device, a notification comprising an authorization request for performing a reset of an electric vehicle supply equipment (EVSE); displaying, by a user interface, the notification; receiving, by the user interface, an indication from a user authorizing the reset of the EVSE; sending, by the wireless communications device, a user authorization of the reset of the EVSE; receiving, by the wireless communications device, an instruction for performing the reset of the EVSE; displaying, by the user interface, the instruction for performing the reset of the EVSE; and sending, by the wireless communications device, a reset request to the EVSE.

Clause 13: The method in accordance with Clause 12, further comprising: sending, by the wireless communications device, a request for the EVSE to charge an electric vehicle, wherein the notification is responsive to the request for the EVSE to charge the electric vehicle.

Clause 14: The method in accordance with any one of Clauses 12-13, further comprising: sending, by the wireless communications device, an indication of at least one of: (i) the EVSE being unable to charge an electric vehicle, or (ii) the EVSE needing to be reset, wherein the notification is responsive to the indication of the at least one of: (i) the EVSE being unable to charge the electric vehicle, or (ii) the EVSE needing to be reset.

Clause 15: The method in accordance with any one of Clauses 12-14, further comprising: receiving, by the wireless communications device, a result of the reset of the EVSE; and displaying, by the user interface, the result.

Clause 16: The method in accordance with Clause 15, wherein: the result of the reset of the EVSE comprises an indication of a successful reset of the EVSE, and the method further comprises displaying, by the user interface, an indication for the user to proceed with charging an electric vehicle using the EVSE.

Clause 17: The method in accordance with any one of Clauses 15-16, wherein: the result of the reset of the EVSE comprises an indication of an unsuccessful reset of the EVSE, and the method further comprises displaying, by the user interface, an indication comprising one or more of: (i) a recommendation to use another EVSE to charge an electric vehicle, or (ii) information related to the other EVSE.

Clause 18: A processing system, comprising: one or more memories comprising computer-executable instructions; and one or more processors configured to execute the computer-executable instructions and cause the processing system to perform a method in accordance with any one of clauses 1-17.

Clause 19: A processing system, comprising means for performing a method in accordance with any one of clauses 1-17.

Clause 20: A non-transitory computer-readable medium storing program code for causing a processing system to perform the steps of any one of clauses 1-17.

Clause 21: A computer program product embodied on a computer-readable storage medium comprising code for performing a method in accordance with any one of clauses 1-17.

Clause 22: A processing system, comprising: one or more memories; and one or more processors, coupled to the one or more memories, configured to cause the processing system to perform a method in accordance with any one of clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular aspects and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the aspects shown and described herein.

What is claimed is:

1. An electric vehicle supply equipment (EVSE), comprising:
a control circuitry within the EVSE, the control circuitry configured to control the EVSE; and
a reset circuitry coupled to the control circuitry, the reset circuitry configured to:
receive a reset signal; and
cause a reset of the EVSE based on the reset signal.

2. The EVSE of claim 1, wherein:
the reset circuitry comprises a wireless communications module configured to:
receive a reset request from a remote wireless communications device, and
send the reset signal to the reset circuitry to cause the reset of the EVSE, the reset signal based on the reset request, the reset request comprising an indication of an authenticated user.

3. The EVSE of claim 1, wherein:
the reset circuitry is coupled to a wireless communications module configured to:
receive a reset request from a remote wireless communications device, and
send the reset signal to the reset circuitry to cause the reset of the EVSE, the reset signal based on the reset request, the reset request comprising an indication of an authenticated user.

4. The EVSE of claim 3, wherein the reset circuitry is coupled to the wireless communications module via at least one general purpose input/output (GPIO) pin connected to a reset point on a Printed Circuit Board (PCB) of the reset circuitry.

5. The EVSE of claim 1, wherein the reset signal is based on a reset request from an authenticated user or a user device of the authenticated user.

6. A method, comprising:
detecting that an electric vehicle supply equipment (EVSE) is not communicating with a remote control system;
setting a status associated with the EVSE indicating an offline state in which the EVSE is not communicating with the remote control system;
receiving, from a user device, at least one of a first request for the EVSE to charge an electric vehicle, or a request to reset the EVSE;
determining whether the reset of the EVSE is allowed in accordance with a reset condition being satisfied; and
sending, to the user device, a notification based on the determination of whether the reset of the EVSE is allowed.

7. The method of claim 6, wherein detecting that the EVSE is not communicating with the remote control system comprises determining that no status update has been received from the EVSE for at least a threshold amount of time.

8. The method of claim 6, wherein:
satisfying the reset condition comprises at least one of:
receiving, from the EVSE, a fault status that can be cleared by the reset of the EVSE;
determining that there is no indication of an unsuccessful reset of the EVSE after detecting that the EVSE is not communicating with the remote control system; or
determining, based on another status associated with the EVSE, that no technician has been contacted for servicing of the EVSE after detecting that the EVSE is not communicating with the remote control system.

9. The method of claim 6, wherein:
determining whether the reset of the EVSE is allowed comprises determining that the reset of the EVSE is allowed, and
sending the notification comprises sending an authorization request to perform the reset of the EVSE.

10. The method of claim 9, further comprising:
receiving, from the user device, an acceptance of the authorization request to perform the reset of the EVSE; and
sending, to the user device, an instruction for performing the reset of the EVSE.

11. The method of claim 10, further comprising determining a result of the reset of the EVSE, wherein:
determining the result of the reset of the EVSE comprises receiving, from the EVSE, an indication of a successful reset of the EVSE, and
the method further comprises sending, to the user device, the indication of the successful reset of the EVSE and an instruction for a user to proceed with charging the electric vehicle using the EVSE.

12. The method of claim 11, further comprising:
generating a log comprising one or more metrics related to the successful reset of the EVSE;
modifying the status associated with the EVSE based on the indication of the successful reset of the EVSE, the modified status indicating an online state in which the EVSE is communicating with the remote control system;
receiving, from the user device, a second request for the EVSE to charge the electric vehicle; and
sending, to the EVSE, an instruction to charge the electric vehicle.

13. The method of claim 11, wherein determining the result of the reset of the EVSE comprises:
determining that the reset of the EVSE was unsuccessful based on receiving no status update regarding the result of the reset of the EVSE for at least a threshold amount of time, and
the method further comprises:
generating a log comprising one or more metrics related to the unsuccessful reset of the EVSE;
maintaining the status associated with the EVSE based on determining that the reset of the EVSE was unsuccessful; and
sending, to the user device, an indication of the unsuccessful reset of the EVSE comprising (i) a recommendation to use another EVSE to charge the electric vehicle, and (ii) information related to the other EVSE.

14. The method of claim 6, wherein:
determining whether the reset of the EVSE is allowed comprises determining that the reset of the EVSE is not allowed, and
sending the notification comprises sending an indication that the reset of the EVSE is not allowed, the notification comprising (i) a recommendation to use another EVSE to charge the electric vehicle, and (ii) information related to the other EVSE.

15. A method, comprising:
receiving, by a wireless communications device, a notification comprising an authorization request for performing a reset of an electric vehicle supply equipment (EVSE);
displaying, by a user interface, the notification;
receiving, by the user interface, an indication from a user authorizing the reset of the EVSE;
sending, by the wireless communications device, a user authorization of the reset of the EVSE;
receiving, by the wireless communications device, an instruction for performing the reset of the EVSE;
displaying, by the user interface, the instruction for performing the reset of the EVSE; and
sending, by the wireless communications device, a reset request to the EVSE.

16. The method of claim 15, further comprising:
sending, by the wireless communications device, a request for the EVSE to charge an electric vehicle,
wherein the notification is responsive to the request for the EVSE to charge the electric vehicle.

17. The method of claim 15, further comprising:
sending, by the wireless communications device, an indication of at least one of: (i) the EVSE being unable to charge an electric vehicle, or (ii) the EVSE needing to be reset,
wherein the notification is responsive to the indication of the at least one of: (i) the EVSE being unable to charge the electric vehicle, or (ii) the EVSE needing to be reset.

18. The method of claim 15, further comprising:
receiving, by the wireless communications device, a result of the reset of the EVSE; and
displaying, by the user interface, the result.

19. The method of claim 18, wherein:
the result of the reset of the EVSE comprises an indication of a successful reset of the EVSE, and
the method further comprises displaying, by the user interface, an indication for the user to proceed with charging an electric vehicle using the EVSE.

20. The method of claim 19, wherein:
the result of the reset of the EVSE comprises an indication of an unsuccessful reset of the EVSE, and
the method further comprises displaying, by the user interface, an indication comprising one or more of: (i) a recommendation to use another EVSE to charge an electric vehicle, or (ii) information related to the other EVSE.
